(19) United States
(12) Patent Application Publication
(10) Pub. No.: US 2015/0150432 A1
(43) Pub. Date: Jun. 4, 2015

(54) DOMESTIC APPLIANCE HAVING A LOCKING ARRANGEMENT AND A DOOR-WEIGHT-COMPENSATION SYSTEM

(71) Applicant: BSH Bosch und Siemens Hausgeräte GmbH, Munich (DE)

(72) Inventors: Christian Ertl, Holzheim (DE); Markus Höpfl, Lauingen (DE); Markus Konrad, Bissingen (DE); Walter Lippert, Wertingen (DE); Jochen Müller, Dillingen (DE); Christoph Thiel, Lauingen (DE)

(21) Appl. No.: 14/406,229

(22) PCT Filed: Jun. 19, 2013
(86) PCT No.: PCT/EP2013/062694

§ 371 Date: Dec. 8, 2014

(30) Foreign Application Priority Data
Jun. 29, 2012 (DE) 10 2012 211 254.5

(51) Int. Cl. A47L 15/42; E05F 1/10; E05F 3/18

(52) U.S. Cl. CPC A47L 15/4261; E05F 3/18; E05F 1/1041; A47L 15/4259; E05Y 2900/304

(57) ABSTRACT

A domestic appliance includes a door configured to pivot about a horizontal axis of rotation so as to assume a substantially vertical position when closed to thereby close a treatment chamber. The axis of rotation is arranged behind a center of gravity of the door in a depthwise direction of the domestic appliance. When closed, the door is locked by a locking arrangement. A door weight compensation system damps an opening movement and/or assists a closing movement of the door and is configured to enable the door in an unlocked state to assume a partially open position, in which the door is open to some degree, substantially as a result of a weight-induced force exerted by the door.

The present invention relates to a domestic appliance, in particular a domestic dishwasher, having a locking arrangement and a door weight compensation system.

The unlocking and opening of the door of a conventional dishwasher, for example a dishwasher with a pull-up lock, are associated with a certain expenditure of force on the part of the operator, which in some instances may not appear user-friendly. In the past it has also proven advantageous for the purposes of complete drying to open the door of a dishwasher partially during the drying cycle. There is also frequently a demand for appliance fronts without handles.

Therefore dishwashers with a facility for automatic door opening have very recently been developed. Such a dishwasher is described for example in EP 2 394 561 A2. The door here can be opened automatically by a motor-actuated opening facility in the form of a pressure unit, e.g. in the form of a pressure ram, at least by a gap width. A magnetic coupling is provided here, to ensure that the pressure unit and the door remain detachably coupled.

If the door of the domestic appliance can be pivoted about a horizontal axis of rotation, the in some instances heavy inherent weight of the door on the one hand means that manual closing requires a significant expenditure of force on the part of the user. Also the door reaches a relatively high speed as it opens, which is undesirable from the point of view of safety and user-friendliness. For this reason door weight compensation systems have long been known, which on the one hand assist a closing movement of the door and on the other hand damp the opening movement of the door. Such a door weight compensation system is described by way of example in DE 296 15 527 U1.

One object of the invention is to provide a domestic appliance, in particular a domestic dishwasher, which has a locking arrangement and a door weight compensation system and is characterized by a particularly simple mechanism for the automatic or self-acting opening of the door.

According to the invention this object is achieved by a domestic appliance having the features according to claim 1.

According to this an inventive domestic appliance, in particular a domestic dishwasher, comprises a door that can be pivoted about a horizontal axis of rotation, which in its closed position assumes a substantially vertical position and closes a treatment chamber, a locking arrangement, by means of which the door can be locked in its closed position, and a door weight compensation system for damping an opening movement and/or for assisting a closing movement of the door. The door and door weight compensation system here are designed and set up in such a manner that in the unlocked state the door assumes a partially open position, in which it is open to some degree, substantially, in particular solely, on account of the weight-induced force exerted by the door.

The invention is based on the fundamental concept of not providing additional components, for example pressure rams, opening springs or the like, for the automatic or self-acting opening of the door but of substantially using only the force induced by the weight of the door to generate the torque required for opening. The invention is therefore characterized by a particularly simple structural design, which can be implemented without or almost without additional construction and assembly-related outlay. Depending on the embodiment of the domestic appliance it is also possible for further appliance components that are present anyway, for example a door seal, to exert a force on the door, which additionally assists the automatic opening of the door. According to the invention however at least the substantial proportion of the required torque should be brought about by the force induced by the weight of the door, which means that no additional components are provided, the primary purpose of which is to generate a torque for the automatic opening of the door.

In order to achieve automatic opening with the aid of the force induced by the weight of the door it is necessary for the torque that results substantially from the weight-induced force in the opening direction—hereafter referred to as the opening moment—to be greater than the counter moment acting in the closing direction—hereafter referred to as the closing moment. This closing moment is brought about substantially by the door weight compensation system. However parasitic forces, for example friction forces, can also contribute to this closing moment.

According to the invention it is sufficient to unlock the door in order to bring about an automatic, in other words self-acting, opening of the door. To allow this, it is necessary for the required opening moment already to be acting on the door when the door is in its substantially vertical initial position as it is at the time of unlocking. According to the invention this is achieved in that the axis of rotation of the door is arranged behind the center of gravity of the door in the depthwise direction of the domestic appliance. The depthwise direction here refers to the direction from the appliance front to the rear face of the appliance.

The door and the door weight compensation system should therefore be configured and designed such that when the door is in the upright initial position an opening moment first results, which is greater than the closing moment and when the desired partially open position is reached, a moment equilibrium of the closing and opening moments is reached at the door.

According to one structurally particularly simple embodiment of the invention the door weight compensation system comprises both a tension spring facility and a tension cable and/or door rod system.

For visual and aesthetic reasons it is frequently desirable, in particular with built-in domestic appliances, to provide the door with a decorative plate. In a further embodiment of the invention the door can comprise both a door base body and a decorative plate fastened thereto.

Both from the point of view of user-friendliness, e.g. with the automatic opening of a handle-free door, and taking into account efficiency when opening the door to assist drying it has proven advantageous for the door to be 50 to 150 mm, in particular 90 to 110 mm, open in the partially open position. The dimensions here relate to a distance between the top edge of the door and an upper edge of the opening in the carcass of the domestic appliance, which the door closes or exposes. Generally however a partially open position in the context of the application refers to any intermediate position of the door between its closed, substantially vertical position and its fully open, substantially horizontal position.

The invention and its advantageous configurations and developments along with their advantages are described in more detail in the following with reference to drawings, each of which shows a schematic outline, in which:

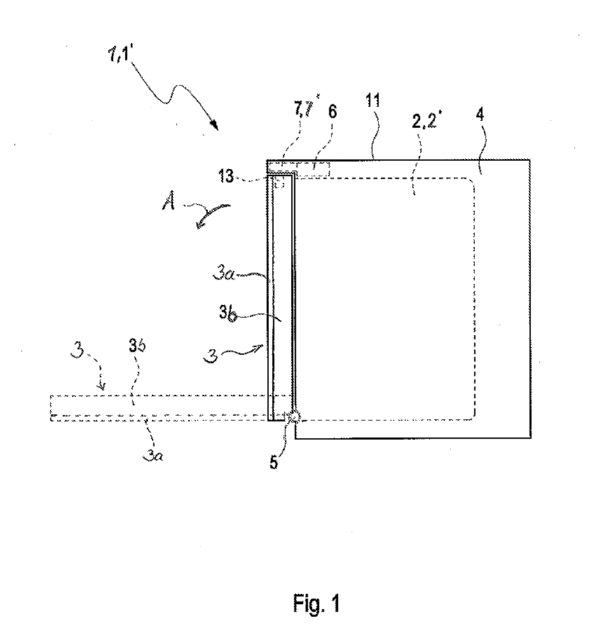

FIG. 1 shows a side view of an inventive dishwasher with the door closed,

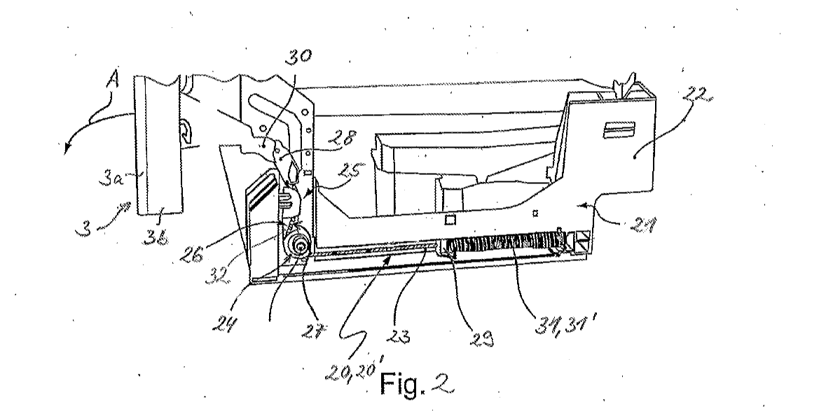

FIG. 2 shows a side view of an embodiment of a door weight compensation system of the dishwasher according to FIG. 1,

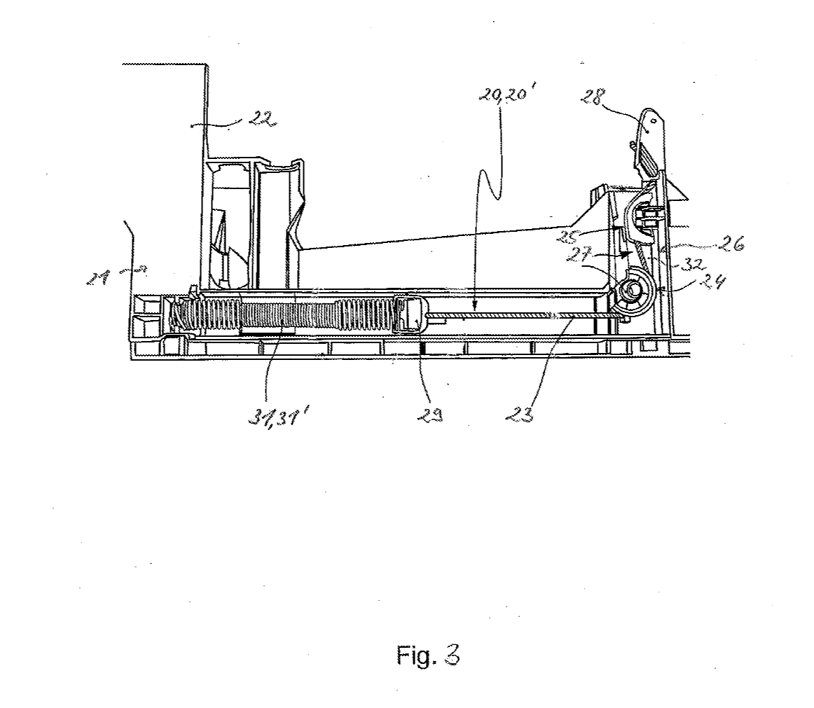

FIG. 3 shows a rather more detailed side view of the door weight compensation system according to FIG. 2,

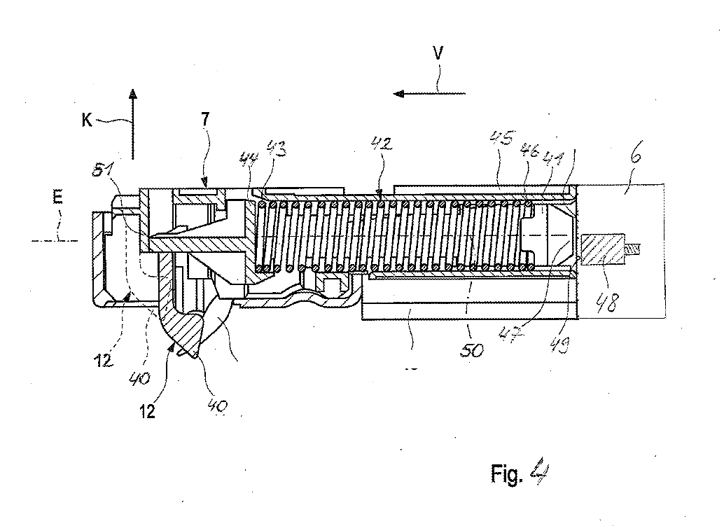

FIG. 4 shows a sectional view of an embodiment of a locking arrangement of the dishwasher according to FIG. 1 and

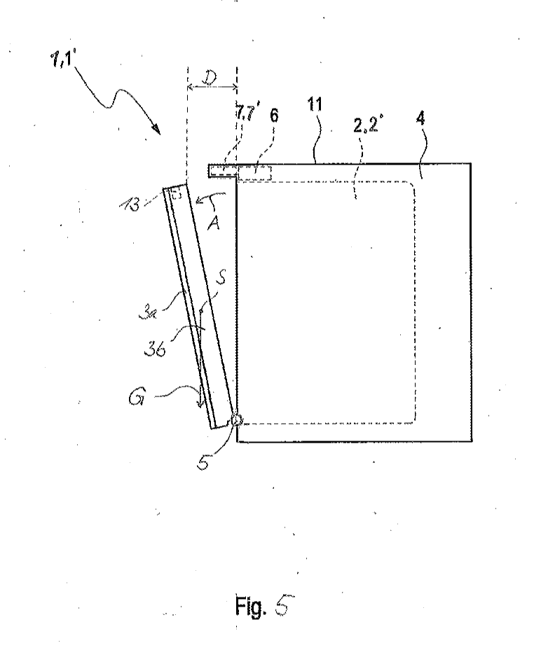

FIG. 5 shows a side view of an inventive dishwasher with the door partially open.

Identical elements or those of identical function are shown with the same reference characters in the figures, unless otherwise stated.

FIG. 1 shows a schematic side view of a domestic appliance 1 in the form of a dishwasher 1′. It has a treatment chamber 2 in the form of a wash container 2′ for holding items to be washed. A door 3 is hinged to a carcass 4 holding the wash container 2′ by means of a hinge (not shown), in such a manner that the door 3 can be pivoted about a low horizontal axis of rotation 5. The closed position of the door 3 is shown with a continuous line here and the fully open position is shown with a broken line. In the closed position the door 3 assumes a substantially vertical position and can be pivoted forward and down about the axis of rotation 5 in the direction of the arrow A to open it. In the illustrated exemplary embodiment the door 3 is configured as handle-free and has a decorative plate 3a, which is fastened to a door base body 3b. However the invention can also be applied to doors with a handle and/or without a decorative plate. The dishwasher 1′ also has an unlocking module 6 and a locking arrangement 7 in the form of a door lock 7′, which are each arranged below an upper covering 11 of the carcass 4.

The door lock 7 comprises an actuation element in the form of a locking element 12 (see FIG. 4), which is configured in the form of a closing bracket according to the exemplary embodiment. Returning to FIG. 1, a cutout 13 is shown there in the door 3, the locking element 12 engaging therein when the door 3 is in the closed position, pulling said door 3 in the direction of the wash container 2′ against a seal (not shown). The seal is arranged around the edge of the opening of the wash container 2′. This allows the wash container 2′ to be closed off in a gas-tight and liquid-tight manner when the door 3 is in the closed position.

The door 3 is connected by way of a door weight compensation system 20, which comprises one or more spring unit(s) 20′, to a non-movable—in other words fixed—region 21 of the dishwasher 1′, the non-movable region 21 in the illustrated exemplary embodiment being formed by a base support 22—frequently also referred to as the floor tray (see FIGS. 2 and 3). Precisely one such spring unit 20′ is preferably provided with axial symmetry on each transverse face of the dishwasher 1′, in other words on the left and right faces of the dishwasher 1′. The door weight compensation system 20 is used both to damp an opening movement and to assist a closing movement of the door 3.

The spring unit 20′ comprises at least one tension cable 23, which can be configured in cross section for example as a flat strip or—as in this instance as a cable with circular symmetry—made for example of metal or a plastic such as polyester. Alternatively an embodiment would also be conceivable in which the tension cable 23 is replaced partially or in its entirety by a rod system. In order to allow different forces to be applied to the door 3 as a function of the door position, in other words the degree of opening of the door 3, the tension cable 23 is passed over a slide 26 comprising at least two sliding surfaces 24, 25 with friction moments that vary as a function of the door position. The slide 26 here forms a laterally open structural unit, which allows the tension cable 23 to be threaded in and out of a through channel 27 located between the sliding surfaces 24, 25 even when fitted on the dishwasher 1′, without threading through one of the fastening ends 28, 29 of the tension cable 23 but by inserting a center region of the tension cable 23 into the through channel 27 from the side. In particular the slide 26 is configured as laterally open with its at least two, preferably fixed sliding surfaces 24, 25 in such a manner that it is possible to insert the tension cable 23 roughly perpendicular to the respective side wall or the respective lateral frame part of the base support 22.

Because of the free accessibility of the slide 26 from the side the tension cable 23 can advantageously be pre-assembled and can be provided at the front with a thickened first fastening end 28 that exceeds the clear width of the through channel 27 of the slide 26 to engage indirectly or directly with a pivot lever 30 assigned to the door 3 that is preferably not fitted until afterwards. This first fastening end 28 can comprise for example a plastic body, in which one end of the tension cable 23 is embedded; in other words the plastic body is injection molded onto the door-side end segment of the tension cable 23. Unlike an eyelet this allows non-rotating connection to the pivot lever 30. Said plastic body can be configured in particular as a coupling element, which can be moved into a park position on the base support 22, in particular on a hinge plate provided in the front edge region of the base support 22. In this park position said coupling element engages with the assigned pivot lever 30 on the door 3, when said door 3 is fitted onto the dishwasher 1′.

Similarly the tension cable 23—again pre-assembled—can be provided at the rear, in other words on the tension spring facility side, with a thickened second fastening end 29 that exceeds the clear width of the through channel 27 of the slide 26 to connect indirectly or directly to a tension spring facility 31. In the illustrated exemplary embodiment this comprises a continuous tension spring 31′. Alternatively it is possible to have a number of springs connected behind and/or adjacent to one another. The second fastening end 29 can be used to connect the tension cable 23 to the tension spring facility 31 in a non-rotating manner. This largely prevents unwanted torsion in the tension cable 23 and/or the tension spring facility 31. It also prevents the coils of the tension spring facility 31 detaching from the second fastening end 29 of the tension cable 23, which would cause the door weight compensation system 20 to fail.

As described above, the slide 26 comprises two or more sliding surfaces 24, 25 located opposite one another and configured in the illustrated exemplary embodiment in the form of guide paths in the shape of circle segments, against which the tension cable 23 rests with a different friction moment as a function of the door opening position. The guide paths are connected to one another in a fixed manner, by way of a carrier unit 32, which adjoins the side wall of the base support 22 assigned to it.

The slide 26 here can as a whole form or comprise an injection molded part at low cost, with both the carrier unit 32 and the sliding surfaces 24, 25 forming single piece components. If one slide 26 is provided in each instance to the left and right of a door 3, both slides 26 are provided with axial symmetry to one another and thus form separate structural units.

The structure of the door lock 7 is described in more detail below with reference to FIG. 4.

The locking element 12 has a hook 40, which engages in the cutout 13 (see FIG. 1) when the locking element 12 is in the locking position. The hook 40 here forms one end of the locking element 12. The other end of the locking element 12 is formed by two arms 87 (only one of the arms 41 can be seen because of the section in FIG. 4). The arms 41 hold a return spring 42 between them, one end 43 of which rests against a segment 44 which is connected in a fixed manner to a housing 45 of the door lock 7 and the other end 46 of which acts against the arms 41. The outermost ends of the arms 41 together form the end 47.

When an actuator 48 (only shown schematically) of the unlocking module 6 (also only indicated schematically) acts directly or indirectly with a pressure surface 49 against the end 47 of the locking element 12, the locking element 12 is moved from its locking position into its unlocking position (shown with a broken line in FIG. 4) in the movement direction V along its movement axis 50. The hook 40 is then moved both in the movement direction V and in a direction K perpendicular to the plane E. Movement in the direction K is brought about in that the door lock 7 has a step 51. When the locking element 12 is in the unlocking position (broken line in FIG. 4), the hook 40 latches with a form fit behind the step 51.

The unlocking module 6, which serves to move the hook 40 in the movement direction K, is only shown schematically in FIG. 4 and can be implemented in many ways. Possible implementations of the unlocking module 6 are described by way of example in the earlier German patent applications 10 2011 007 538.0 and 10 2012 207 836.3.

The cutout 13 (see FIG. 1) is exposed when the locking element 12 is in in the unlocking position, so that the door 3 can be opened automatically. However the door 3 is to be opened partially, not fully here. Partial opening refers to any door position that does not correspond to the substantially vertical initial position when the door 3 is in the closed position and the substantially horizontal position of the door 3 when it is fully open. Automatic opening should preferably move the door 3 into a partially open position, in which the door is 50 to 150 mm, in particular 90 to 110 mm, open. The dimensions here relate to a distance between the top edge of the door 3 and an upper edge of the opening in the carcass 4 of the dishwasher 1′, which the door 3 closes or exposes. FIG. 5 shows the dishwasher 1′ illustrated in FIG. 1 after automatic opening of the door 3. The abovementioned distance between the top edge of the door and the upper edge of the opening in the carcass 4 is shown here as D. Such automatic partial opening of the door 3 is achieved in that the door 3 and the door weight compensation system 20 are designed and set up in such a manner that in the unlocked state the door 3 assumes said partially open position solely on account of the weight-induced force G exerted by the door 3.

As shown in FIGS. 1 and 5, the low horizontal axis of rotation 5 of the door 3 is arranged behind the center of gravity S of the door 3 in the depthwise direction of the dishwasher 1′. This means that immediately after the door 3 is unlocked, in other words at a time when the door 3 is still in its substantially vertical initial position, an opening moment M_open brought about by the weight-induced force G exerted by the door 3 acts on the door 3. In order now to bring about an automatic or self-acting pivoting of the door 3 forward and down about the axis of rotation 5 in the direction of the arrow A, the door weight compensation system 20 is designed and set up in such a manner that the opening moment M_open after the unlocking of the door 3, in other words after the movement of the locking element 12 out of its locking position into its unlocking position, is initially greater than the sum of the counter moments brought about by the door weight compensation system 20—hereafter referred to as closing moment M_close. As the opening angle of the door 3 increases, the closing moment M_close increases and when the desired partially open position (distance D) is reached, moment equilibrium is reached at the door 3, in other words the opening moment M_open and the closing moment M_close are of identical dimension. This means that the door 3 remains in this partially open position.

The closing moment M_close brought about by the door weight compensation system 20 is substantially a function of a spring force brought about by the tension spring facility 30. This is directly influenced by the design and configuration of the tension spring facility 30 itself. The length of the tension cable 23 can also exert an indirect influence. However it is not the absolute length of the tension cable 23 that is significant but the ratio of an actual length to a minimum length required to bridge the distance between the tension spring facility 31 and the pivot lever 30 predetermined substantially by the arrangements and configurations of the tension spring facility 31, the pivot lever 30 and the slide 26 when the door 3 is closed. Put in simple terms a specific excess length (actual length is greater than minimum length) of the tension cable 23 can ensure that the spring force is only active from a predeterminable opening angle of the door 3. Thus by selecting a tension cable 23 of appropriate length it is possible in a very simple manner to achieve the desired effect of automatic partial opening of the door 3, solely brought about by the weight-induced force G exerted by the door 3. The length of the tension cable 23 is selected in such a manner that just as the desired partially open position of the door 3 is reached, a spring force acts that results in a closing moment M_close, which is of identical dimension to the opening moment M_open. As already mentioned above, it is not the absolute length (actual length) of the tension cable 23 that is significant here but the ratio of the actual length to the minimum length required to bridge the distance between the tension spring facility 31 and the pivot lever 30. Therefore the closing moment M_close can be influenced not only by a change in the length of the tension cable 23 but alternatively or additionally also by a specific change in the length of the distance between the tension spring facility 31 and the pivot lever 30. This can be achieved for example by specifically influencing the initial position of the slide 26, as described in DE 196 11 050 A1. Additionally or alternatively to the specific lengthening of the tension cable 23 and/or the specific displacement of the slide 26, the tension spring facility 30 can of course also be designed and set up in such a manner that the necessary closing moment M_close is brought about when the desired partially open position of the door 3 is reached.

Of course when designing and configuring the tension cable 23 and the tension spring facility 30 all further forces, in particular friction forces, e.g. in the region of the sliding surfaces 24 and 25, should be taken into account, if they also contribute to the closing moment M_close. Conversely of course parasitic forces should also be taken into account if they contribute to the opening moment M_open. It is therefore conceivable for example for the seal arranged around the edge of the opening of the wash container 2′ to contribute in this manner. To realize the invention it is however important that all the parasitic forces resulting in an increase in the opening moment M_open are brought about by components, the primary purpose of which is not the automatic opening of the door 3.

The invention has been explained using the example of a dishwasher but it can also be applied without restriction to other domestic appliances with a door that can be pivoted about a horizontal axis of rotation, a locking arrangement and a door weight compensation system. The specifically described embodiment of the door weight compensation system should also be seen simply as an example. The invention can of course also be applied to domestic appliances with alternatively configured door weight compensation systems. The same also applies in respect of the configuration of the locking arrangement.

List of reference characters

| | |
|---|---|
| 1 | Domestic appliance |
| 1′ | Dishwasher |
| 2 | Treatment chamber |
| 2′ | Wash container |
| 3 | Door |
| 3a | Decorative plate |
| 3b | Door base body |
| 4 | Carcass |
| 5 | Axis of rotation |
| 6 | Unlocking module |
| 7 | Locking arrangement |
| 7′ | Door lock |
| 11 | Covering (of carcass) |
| 12 | Locking element |
| 13 | Cutout |
| 20 | Door weight compensation system |
| 20′ | Spring unit |
| 21 | Non-movable region |
| 22 | Base support |
| 23 | Tension cable |
| 24 | Sliding surface |
| 25 | Sliding surface |
| 26 | Slide |
| 27 | Through channel |
| 28 | First fastening end (of tension cable) |
| 29 | Second fastening end (of tension cable) |
| 30 | Pivot lever |
| 31 | Tension spring facility |
| 31′ | Tension spring |
| 32 | Carrier unit |
| 40 | Hook |
| 41 | Arm |
| 42 | Return spring |
| 43 | First end (of return spring) |
| 44 | Segment |
| 45 | Housing (of door lock) |
| 46 | Second end (of return spring) |
| 47 | End (of locking element) |
| 48 | Actuator (of unlocking module) |
| 49 | Pressure surface (of actuator) |
| 50 | Movement axis |
| 51 | Step |
| A | Pivot direction (when door opening) |
| D | Distance |
| E | Plane |
| G | Weight-induced force (exerted by door) |
| S | Center of gravity (of door) |
| V | Movement direction (of locking element) |
| K | Direction (perpendicular to plane E) |

1-5. (canceled)

6. A domestic appliance, comprising:
a door configured to pivot about a horizontal axis of rotation so as to assume a substantially vertical position when closed to thereby close a treatment chamber, said axis of rotation being arranged behind a center of gravity of the door in a depthwise direction of the domestic appliance,
a locking arrangement configured to lock the door when closed, and
a door weight compensation system for damping an opening movement and/or assisting a closing movement of the door, said door weight compensation system being configured to enable the door in an unlocked state to assume a partially open position, in which the door is open to some degree, substantially as a result of a weight-induced force exerted by the door.

7. The domestic appliance of claim 6, constructed in the form of a dishwasher.

8. The domestic appliance of claim 6, wherein the door assumes the partially open position solely as a result of the weight-induced force exerted by the door.

9. The domestic appliance of claim 6, wherein the door weight compensation system comprises a tension spring facility which is configured to connect the door to a fixed region of the domestic appliance, said tension spring facility including a force-transmitting member operatively connected to the door.

10. The domestic appliance of claim 9, wherein the force-transmitting member is a tension cable and/or a door rod system.

11. The domestic appliance of claim 6, wherein the door comprises a door base body and a decorative plate fastened to the base body.

12. The domestic appliance of claim 6, wherein the door is open by 50 to 150 mm, when assuming the partially open position.

13. The domestic appliance of claim 6, wherein the door is open by 90 to 110 mm, when assuming the partially open position.
